(19) United States
(12) Patent Application Publication
(10) Pub. No.: US 2025/0128637 A1
(43) Pub. Date: Apr. 24, 2025

(54) POWER SYSTEM FOR WORK MACHINES

(71) Applicant: Caterpillar Underground Mining Pty. Ltd., South Burnie (AU)

(72) Inventors: Steven Robert Krause, Chillicothe, IL (US); Martin Victor Pilgrim, Tasmania (AU)

(73) Assignee: Caterpillar Underground Mining Pty. Ltd., South Burnie (AU)

(21) Appl. No.: 18/489,968

(22) Filed: Oct. 19, 2023

(51) Int. Cl. B60L 53/80; B60L 50/60; H02J 7/00

(52) U.S. Cl. CPC B60L 53/80; H02J 7/0036; B60L 50/60; B60L 2200/40

(57) ABSTRACT

A power system for a work machine includes a connection arrangement. The connection arrangement facilitates an operative engagement of terminal sets to provide passage to an electrical connection therethrough and route electrical power supply from electrical power sources to electrical devices of the work machine through the connection arrangement. Further, the connection arrangement facilitates an operative engagement of connector sets to provide passage to communication links therethrough and route data transmission through the connection arrangement. A system for determining a state of the electrical connection between the terminal sets includes a controller configured to detect the data transmission through the communication links; determine the state of the electrical connection between the terminal sets as connected when the data transmission is active; and determine the state of the electrical connection between the terminal sets as disconnected when the data transmission is inactive.

### TECHNICAL FIELD

The present disclosure relates generally to a power system in a work machine. More particularly, the present disclosure relates to determining a state of an electrical connection between various terminal sets that facilitate power supply (e.g., from a battery) to one or more electrical devices of the work machine.

### BACKGROUND

A work machine, such as those applied in construction and mining environments, e.g., excavators, loaders, trucks, and the like machines, may use electrical power for accomplishing various tasks, such as machine motion and implement actuation. Electrical power in such machines is typically sourced from an electrical power source, e.g., a battery, generally provided within a power compartment of the work machine. Some work machines are designed to allow a discharged battery to be exchanged for a fully charged battery. It is commonly needed to detect whether a battery (e.g., a fully charged battery) is properly electrically connected to the work machine devices, or not, e.g., when a new or a fully charged battery pack is installed onto the work machine. Manual checks may be performed to detect the state of the electrical connection of the battery, but they are labor intensive and prone to error.

Chinese Publication No.: 115,771,427 relates to an electric system for replacing an electric power battery. The electric system includes a BDU assembly respectively connected with a power battery and a quick-change connector at high voltage and comprises a main contactor, a pre-charging resistor, and a fuse, which are sequentially and electrically connected. The quick-change electric connector is used for realizing high-voltage connection between the power battery and a vehicle and simultaneously is connected with a low-voltage wire harness on the vehicle. The BMS is in communication connection with the VCU and is used for detecting the voltage and the current of the power battery and the temperature of a high-voltage terminal of the quick-change electric connector, detecting whether the quick-change electric connector is matched in place or not and performing fault diagnosis; the locking mechanism monitoring sensor is used for detecting whether a locking hook of the power battery locking mechanism is locked in place or not; the VCU is used for carrying out fault processing according to fault information provided by the BMS and an unlocked in-place signal provided by the locking mechanism monitoring sensor.

### SUMMARY OF THE INVENTION

In one aspect, the disclosure relates to a power system for a work machine. The power system includes a connection arrangement. The connection arrangement is configured to be moved between a mated state and an unmated state to facilitate replacement of one or more electrical power sources of the work machine. In the mated state, the connection arrangement facilitates an operative engagement of a first terminal set with a second terminal set to provide passage to an electrical connection therethrough and route electrical power supply from the electrical power sources to one or more electrical devices of the work machine through the connection arrangement. Further, in the mated state, the connection arrangement facilitates an operative engagement of a first connector set with a second connector set to provide passage to one or more communication links therethrough and route data transmission through the connection arrangement. The power system further includes a system for determining a state of the electrical connection between the first terminal set and the second terminal set. The system includes a controller. The controller is configured to detect the data transmission through the communication links; determine the state of the electrical connection between the first terminal set and the second terminal set at the connection arrangement as connected when the data transmission is active; and determine the state of the electrical connection between the first terminal set and the second terminal set at the connection arrangement as disconnected when the data transmission is inactive.

In another aspect, the disclosure is directed to a method of operation of a power system of a work machine. The method includes moving a connection arrangement of the power system between a mated state and an unmated state to facilitate replacement of one or more electrical power sources of the work machine. In the mated state of the connection arrangement, the connection arrangement facilitates an operative engagement of a first terminal set with a second terminal set to provide passage to an electrical connection therethrough and route electrical power supply from the electrical power sources to one or more electrical devices of the work machine through the connection arrangement. Further, in the mated state of the connection arrangement, the connection arrangement facilitates an operative engagement of a first connector set with a second connector set to provide passage to one or more communication links therethrough and route data transmission through the connection arrangement. The method includes detecting, by a controller, the data transmission through the communication links; determining, by the controller, a state of the electrical connection between the first terminal set and the second terminal set as connected when the data transmission is active; and determining, by the controller, the state of the electrical connection between the first terminal set and the second terminal set as disconnected when the data transmission is inactive.

In yet another aspect, the disclosure relates to a work machine. the work machine includes one or more electrical power sources, one or more electrical devices powerable by the electrical power sources, a first terminal set and a second terminal set configured to be operatively engaged with each other to provide passage to an electrical connection therethrough for facilitating electrical power supply from the electrical power sources to the electrical devices. The work machine also includes a first connector set and a second connector set configured to be operatively engaged with each other to provide passage to one or more communication links therethrough for facilitating data transmission therethrough. Further, the work machine includes a power system including a connection arrangement configured to be moved between a mated state and an unmated state to facilitate replacement of the electrical power sources. In the mated state, the connection arrangement facilitates an operative engagement of the first terminal set with the second terminal set to route the electrical power supply through the connection arrangement, and an operative engagement of the first connector set with the second connector set to route the data transmission through the connection arrangement. The power system includes a system for determining a state of the electrical connection between the first terminal set and the second terminal set. The system includes a controller configured to detect the data transmission through the communication links, determine the state of the electrical connection between the first terminal set and the second terminal set at the connection arrangement as connected when the data transmission is active, and determine the state of the electrical connection between the first terminal set and the second terminal set at the connection arrangement as disconnected when the data transmission is inactive.

### BRIEF DESCRIPTION OF THE DRAWINGS

FIG. 1 are exemplary side views of a work machine illustrating replacement of an electrical power source of the work machine, in accordance with one or more aspects of the present disclosure;

FIGS. 2 and 3 are schematic views illustrating a mated state and an unmated state of a connection arrangement of a power system of the work machine, in accordance with one or more aspects of the present disclosure;

FIGS. 4 and 5 illustrate an actuation of the connection arrangement between the mated state and the unmated state by use of an actuator, in accordance with one or more aspects of the present disclosure; and

FIG. 6 is a flowchart illustrating an exemplary method of operation of the power system of the work machine, in accordance with one or more aspects of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

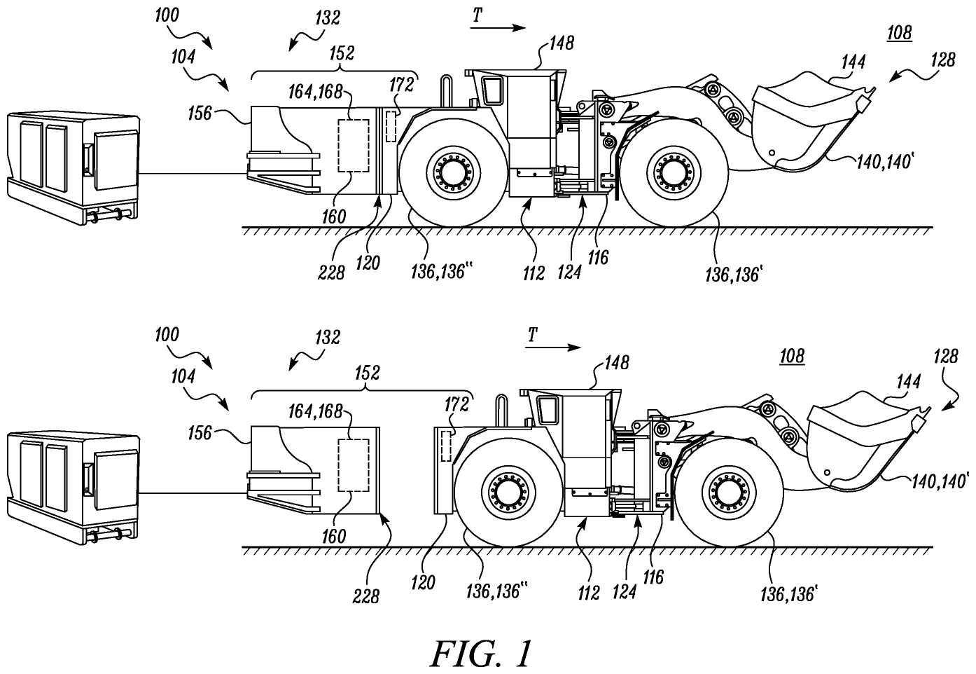

Referring to FIGS. 1 through 3, a work machine 100 is shown. The work machine 100 may be electrically powered, either partly or fully, and, in one embodiment, may embody an electrically operated machine or simply an electric work machine 104. The work machine 100 may be applied at a worksite 108 that may correspond to a mining environment and may exemplarily embody a load-haul-dump (LHD) machine that may be applicable in working environments, such as underground mining environments. It is possible, however, for the work machine 100 to embody various other types of work machines which may be applicable in other environments, such as over ground mining environment, a construction environment, and the like working environments, as well. Effectively, aspects of the present disclosure may be applicable to various such work machine, and the work machine 100 illustrated and described in this present disclosure may be exemplary.

The work machine 100 may include a main frame assembly 112 that may exemplarily include a split frame configuration enabling the work machine 100 to acquire a forward portion 116 and a rearward portion 120 which may be articulable with respect to each other (e.g., at a hitch joint 124). The forward portion 116 may define a forward end 128 of the work machine 100, while the rearward portion 120 may define a rearward end 132 of the work machine 100. The work machine 100 may include traction devices 136—e.g., the forward portion 116 may include forward wheels 136′, while the rearward portion 120 may include rearward wheels 136″.

Unless specified otherwise, terms such as ‘forward’, ‘front’, ‘rear’, ‘rearward’, as may be used in the present disclosure may be understood according to an exemplary direction, T, in which the work machine 100 may move during operations. Said exemplary direction, T, may be defined from the rearward end 132 towards the forward end 128 of the work machine 100.

The forward portion 116 may include an implement 140 of the work machine 100. The implement 140 may include a bucket 140′ that may be articulable so as to receive and haul load 144. The rearward portion 120 may include an operator cabin 148 and a power generating portion 152 of the work machine 100. The operator cabin 148 may be configured to house one or more operators and may also include multiple input devices or operator interfaces, such as joysticks, touchscreens, etc., (not shown) for the control of the many functions of the work machine 100, e.g., machine motion (e.g., by powering the traction devices 136) and/or implement actuation. The power generating portion 152 may include a power compartment 156 which may enclose or house a power source 160 of the work machine 100. As an example, the power source 160 may include an electrical power source 164, such as a battery module 168.

The electrical power source 164 may be configured to power various electrical devices of the work machine 100, enabling the electrical devices to perform useful work. For example, the electrical power source 164 may enable the work machine's travel or movement over and across the worksite 108. Additionally, the electrical power source 164 may also power an actuation of the implement 140 such that the implement 140 can perform one or more work related functions of the work machine 100. In effect, the electrical devices may correspond to one or more of the traction devices 136 (e.g., the forward wheels 136′ and/or the rearward wheels 136″), one or more actuators (not shown) associated with the movement (e.g., tilting, pivoting, etc.) of the implement 140, and the like devices. For ease in reference, the electrical devices may be referred to in the singular, i.e., as an electrical device 172, but the same may refer to one or more electrical devices of the work machine 100. Also, exemplarily, the electrical device 172 has been illustrated schematically in FIGS. 1 through 5 but can refer to one or more of the electrical devices discussed above.

As an example, the electrical power source 164 or the battery module 168 may include a single battery, although the electrical power source 164 or the battery module 168 may represent and/or include multiple batteries. In one example, electrical power from the electrical power source 164 may be provided to various intermediary devices, such as inverters and/or converters (not shown) before having the electrical power supplied to one or more of the electrical devices (e.g., the electrical device 172) of the work machine 100. Also, the electrical power source 164 may include a first controller 176 having a first receiver 180 (e.g., in the form of a transceiver-which may be referred to as a first transceiver 184), while the electrical device 172 may include a second controller 188 having a second receiver 192 (e.g., also in the form of a transceiver-which may be referred to as a second transceiver 196).

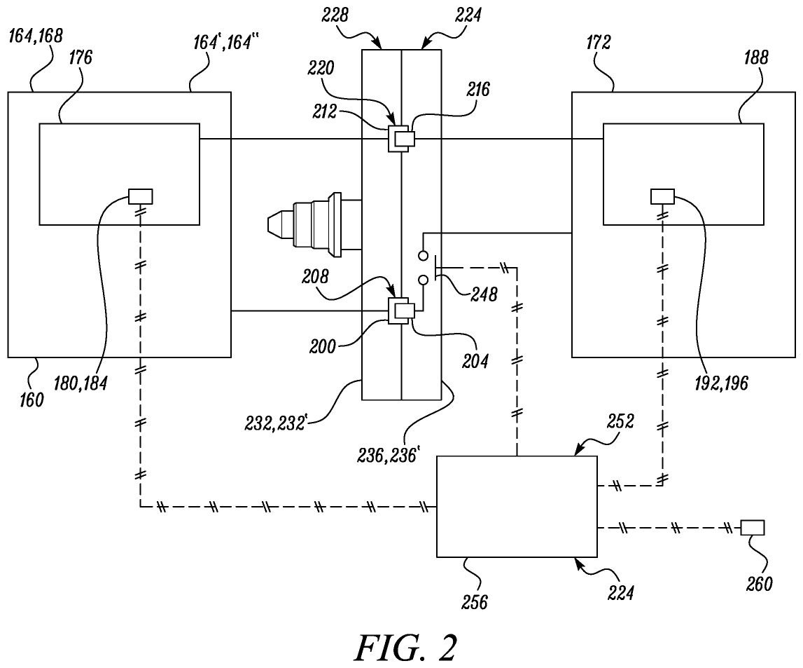

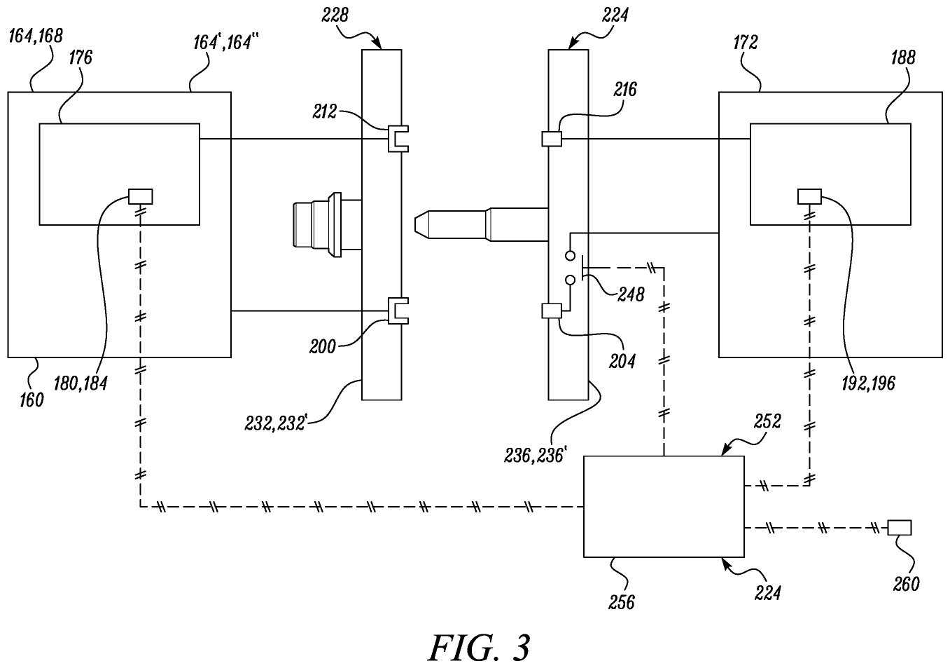

Referring to FIGS. 2 and 3, the power generating portion 152 may include electrical power contacts, e.g., a first terminal set 200 and a second terminal set 204. The first terminal set 200 and the second terminal set 204 may be configured to be operatively engaged with each other (e.g., one may retentively receive the other to be mechanically connected to each other) to form and/or provide passage to an electrical connection 208 (e.g., a relatively high power electrical connection) (see FIG. 2) therethrough for facilitating electrical power supply from the electrical power source 164 to the electrical device 172. Specification and/or configurations of the first terminal set 200 and the second terminal set 204 may be contemplated by someone in the art, and thus can include any specification and/or configuration now known or in the future developed.

Similarly, the power generating portion 152 may also include datalink signal contacts, e.g., a first connector set 212 and a second connector set 216. The first connector set 212 and the second connector set 216 may be configured to be operatively engaged with each other (e.g., one may retentively receive the other to be mechanically connected to each other) to form and/or provide passage to one or more communication links (e.g., see communication link 220, which may be a relatively low power communication link) therethrough for facilitating data transmission therethrough. Although not limited, the communication link 220 is configured to be passed between the electrical power source 164 and the electrical device 172 of the work machine 100. In that manner, data may be transmitted between the electrical power source 164 and the electrical device 172. Specification and/or configurations of the first connector set 212 and the second connector set 216 may be contemplated by someone in the art, and thus can include any specification and/or configuration now known or in the future developed.

Alternatively, the communication link 220 may be configured to passed between any two or more devices of the work machine 100 between which data transmission is possible, and the passage between the electrical power source 164 and the electrical device 172 may be viewed as exemplary. Also, data transmissible through the communication link 220 may correspond to one or more of digital data, analog signal data, optical data, and fluid based signal data capable of facilitating a handshake type function with various devices of the work machine 100, or a combination of these.

Further, the power generating portion 152 may include a power system 224. According to one or more aspects of the present disclosure, the power system 224 may enable the electrical power source 164 to selectively (and electrically) be coupled and decoupled with respect to the electrical device 172 of the work machine 100. The selective coupling and decoupling of the electrical power source 164 with respect to the electrical device 172 of the work machine 100 may allow an old/used electrical power source (referred to as a drained electrical power source 164) of the work machine 100 to be replaced with a new/charged or a fully charged electrical power source (referred to as a charged electrical power source 164) of the work machine 100—for ease in understanding, both references 164, and 164 are marked against the same electrical power source 164. To this end, the power system 224 may include a connection arrangement 228.

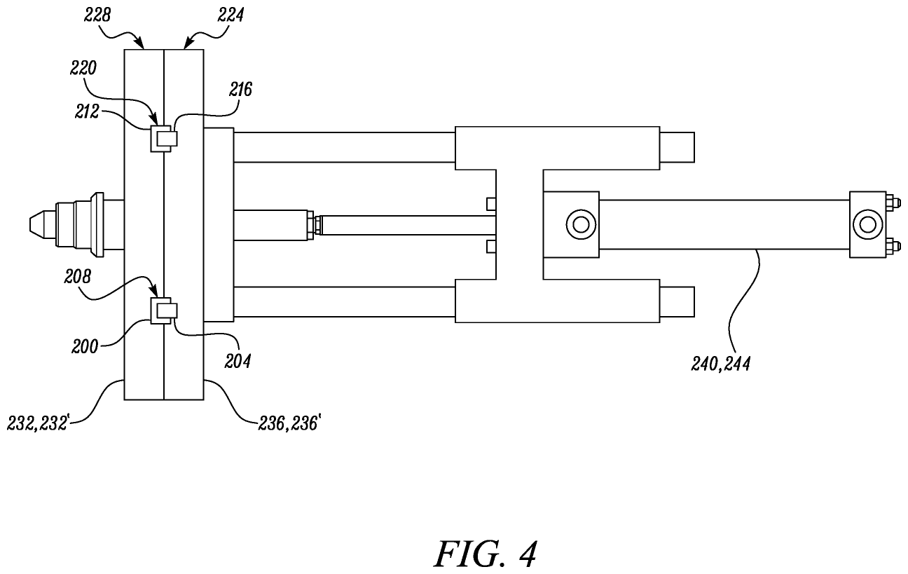

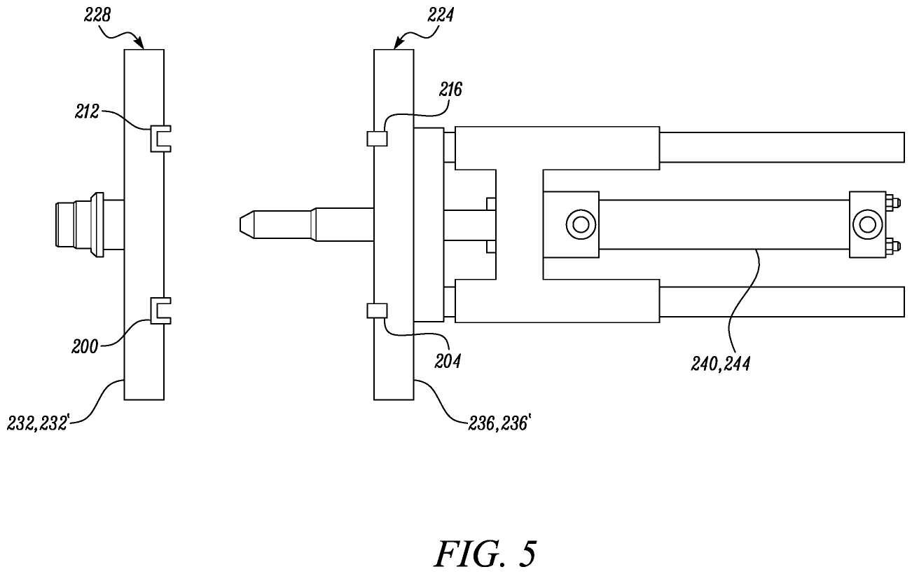

The connection arrangement 228 of the power system 224 allows the power system 224 to selectively couple and decouple the electrical power source 164 with respect to the electrical device 172, as noted above. In this regard, the connection arrangement 228 may include a first piece 232 and a second piece 236. The first piece 232 may carry the first terminal set 200 and the first connector set 212 (e.g., which may include connections or cablings extending from the electrical power source 164), while the second piece 236 may carry the second terminal set 204 and the second connector set 216 (e.g., which may include connections or cablings extending from the electrical device 172). The second piece 236 may be complementary to the first piece 232 such that the first piece 232 may be switchable between a connected condition and a disconnected condition with respect to the second piece 236. In that manner, one or more of the first piece 232 and the second piece 236 may be actuated to be moved away or moved towards the other of the first piece 232 and the second piece 236 such that the connection arrangement 228 can attain a mated state (e.g., see FIG. 2) and an unmated state (e.g., see FIG. 3). The movement can be exemplarily effectuated by way of an actuator 240 (e.g., a fluid actuator 244) (see FIGS. 4 and 5). It may be noted that in FIGS. 4 and 5, an exemplary configuration of the connection arrangement 228, provided with the actuator 240, omits certain components of the power system 224 illustrated in FIGS. 2 and 3. This is to better illustrate an exemplary configuration of the actuator 240 with the connection arrangement 228.

In that manner, the connection arrangement 228 may be moved between a mated state and an unmated state to facilitate the replacement of the electrical power source 164 (e.g., a removal of the drained electrical power source 164 and an installation of the charged electrical power source 164″) with respect to the work machine 100. One or more of the first piece 232 and the second piece 236 may be in the form of corresponding plates 232, 236′, although variations to their shapes and/or sizes may be contemplated by someone in the art based on the description provided in the present disclosure.

In further detail, the connected condition of the first piece 232 with the second piece 236 may relate to the mated state of the connection arrangement 228 and may also correspond to the operative engagement (e.g., mechanical connection) of the first terminal set 200 with the second terminal set 204 and the operative engagement (e.g., mechanical connection) of the first connector set 212 with the second connector set 216. In other words, in the mated state of the connection arrangement 228, e.g., when the first piece 232 is in the connected condition with respect to the second piece 236, the connection arrangement 228 facilitates an operative engagement (e.g., mechanical connection) of the first terminal set 200 with the second terminal set 204 to route the electrical power supply through (or across) the connection arrangement 228. Also, in the mated state of the connection arrangement 228, e.g., when the first piece 232 is in the connected condition with respect to the second piece 236, the connection arrangement 228 facilitates an operative engagement (e.g., mechanical connection) of the first connector set 212 with the second connector set 216 to route the data transmission through (or across) the connection arrangement 228.

According to an aspect of the present disclosure, when the connection arrangement 228 is moved to the mated state, the first terminal set 200 and the second terminal set 204 may be operatively engaged or mechanically connected to each other and also the first connector set 212 and the second connector set 216 may be operatively engaged or mechanically connected to each other, at the same time or simultaneously. However, in such a case, it may be noted that the data transmission (through the communication link 220) may be actuated prior to the actuation of the electrical supply (through the electrical connection 208).

Conversely, the disconnected condition of the first piece 232 with the second piece 236 may relate to the unmated state of the connection arrangement 228 and may also correspond to a disengagement (e.g., mechanical disconnection) between the first terminal set 200 and the second terminal set 204. Such disengagement between the first terminal set 200 and the second terminal set 204 may restrict the electrical power supply through (or across) the electrical connection 208. Further, the disconnected condition of the first piece 232 with the second piece 236 may also correspond to a disengagement (e.g., mechanical disconnection) between the first connector set 212 and the second connector set 216. Such disengagement between the first connector set 212 and the second connector set 216 may also restrict the data transmission through (or across) the communication link 220.

According to an aspect of the present disclosure, when the connection arrangement 228 is moved to the unmated state, the first terminal set 200 and the second terminal set 204 may be disengaged or mechanically disconnected from each other and also the first connector set 212 and the second connector set 216 may be disengaged or mechanically disconnected from each other, at the same time or simultaneously. However, in such a case, it may be noted that the data transmission (through the communication link 220) may be stopped or halted prior to the cut off of the electrical supply (through the electrical connection 208).

In some embodiments, the power system 224 may include one or more electrical-contactors (e.g., see electrical-contactor 248) provided on the electrical connection 208. The electrical-contactor 248 may be configured to be switched between an ON condition (e.g., closed position) and an OFF condition (e.g., open position). The condition illustrated in each of FIGS. 2 and 3 of the electrical-contactor 248 exemplarily corresponds to the OFF condition (e.g., open position) of the electrical-contactor 248.

Additionally, and according to yet some aspects of the present disclosure, the power system 224 also helps detect a state of the electrical connection 208 between the electrical power source 164 and the electrical device 172, e.g., while removing the drained electrical power source 164 from the work machine 100 and/or while installing the charged electrical power source 164″ to the work machine 100. Such state of the electrical connection 208 may be detected when the connection arrangement 228 is in the mated state (e.g., see FIG. 2). To this end, the power system 224 may further include a system 252 for determining a state of the electrical connection 208 between the first terminal set 200 and the second terminal set 204. The system 252 includes a controller 256, details of which shall be discussed below.

With continued reference to FIGS. 2 and 3, the controller 256 may be communicably coupled to at least one of the electrical power source 164 and/or the electrical device 172. Optionally, or additionally, the controller 256 may also be communicably coupled to at least one of the first connector set 212 and/or the second connector set 216. Further, the controller 256 may be operatively coupled to one or more operator interfaces as well, e.g., operator interfaces that may be provided with the operator cabin 148. Furthermore, the controller 256 may also be communicably coupled to a memory 260 (which may be one of integrally or externally configured with the controller 256). Moreover, the controller 256 may be operatively coupled to the electrical-contactor 248 so as to switch the electrical-contactor 248 between the closed position and the open position.

As an example, by way of the controller's communicable coupling with one or more of the electrical power source 164 and/or the electrical device 172, the controller 256 may be configured to detect the data transmission through the communication link 220. Such detection of data transmission through the communication link 220 can be performed by the controller 256 as the controller 256 may monitor receipt of data to the first receiver 180 which may be associated with the electrical power source 164. Alternatively, or additionally, such detection of data transmission through the communication link 220 can be performed by the controller 256 as the controller 256 may monitor receipt of data to the second receiver 192 which may be associated with the electrical device 172. The communicable coupling, noted above, may correspond to one or more of a wired connection or a wireless connection.

In some embodiments, the controller 256 may correspond to or include the first controller 176 associated with the electrical power source 164, and as an example, may be part of an integral control unit associated with the electrical power source 164. In some alternate embodiments, the controller 256 may correspond to or include the second controller 188 associated with the electrical device 172, and as an example, may be part of an integral control unit associated with the electrical device 172. In yet some further embodiments, the controller 256 may be separate from the electrical power source 164 and the electrical device 172, as exemplarily illustrated in each of FIGS. 2 and 3, and to detect data transmission, the controller 256 may monitor the receipt of data to one or both of the first receiver 180 and the second receiver 192.

In some embodiments, the controller 256 may use the activity of monitoring the data receipt by one or more of the first receiver 180 and the second receiver 192 as input or a trigger for further operation. In this regard, and as part of an exemplary further operation, the controller 256 may be able to extract or retrieve a set of instructions from the memory 260 and execute or process (e.g., by suitable processing units) the set of instruction as soon as the controller 256 senses said input or trigger or as soon as the controller 256 monitors the data receipt by one or more of the first receiver 180 and/or the second receiver 192. By executing or processing the set of instructions, the controller 256 may determine the state of the electrical connection 208 between the first terminal set 200 and the second terminal set 204 at the connection arrangement 228.

As an example, the controller 256 may determine the state of the electrical connection 208 between the first terminal set 200 and the second terminal set 204 at the connection arrangement 228 as connected when the data transmission is active (e.g., when data is received by one or more of the first receiver 180 and the second receiver 192). Alternatively, the controller 256 may determine the state of the electrical connection 208 between the first terminal set 200 and the second terminal set 204 at the connection arrangement 228 as disconnected when the data transmission is inactive (e.g., when data is not received by one or more of the first receiver 180 and the second receiver 192). In so doing, the communication link 220 acts or serves as a sensor or a sensing means to detect a mechanical state of the electrical connection 208, e.g., whether the first terminal set 200 is operatively engaged with the second terminal set 204, or not.

As an example, the controller 256 may perform the monitoring of the data receipt by one or more of the first receiver 180 and the second receiver 192 automatically, e.g., without any command, as soon as the data transmission through the communication link 220 is initiated. Such detection may then be used by the controller 256 as input or a trigger for performing further operation. In alternate embodiments, however, the controller 256 may perform the monitoring of the data receipt by one or more of the first receiver 180 and the second receiver 192 and/or detect the data transmission through the communication link 220 (e.g., only) in response to a command (e.g., an operator command which may be issued from the operator interface of the operator cabin 148).

In some further embodiments, the controller 256 may be configured to move the electrical-contactor 248 to the open position (OFF condition) when the data transmission is inactive. In so doing, the controller 256 enables to break (e.g., positively break) any operative engagement between the first terminal set 200 and the second terminal set 204 and helps set a voltage transfer value between the first terminal set 200 and the second terminal set 204 to zero (0) volt at the connection arrangement 228. Further, when the controller 256 detects the data transmission is active (e.g., by monitoring data receipt by one or more of the first receiver 180 and/or the second receiver 192), the controller 256 may move (or return) the electrical-contactor 248 to the closed position (ON condition) to electrically connect and bridge (e.g., positively bridge) the operative engagement between the first terminal set 200 and the second terminal set 204 to provide passage to the electrical connection 208.

The controller 256 may be a microprocessor-based device, and/or may be envisioned as an application-specific integrated circuit, and/or other logic devices, which provide controller functionality, and such devices being known to those with ordinary skill in the art. In one example, it is possible for the controller 256 to include or be representative of one or more controllers having separate or integrally configured processing units to process a variety of data (or input or commands). In some embodiments, a transmission of data between the controller 256 and various other devices, e.g., the first controller 176, the second controller 188, the first receiver 180, and the second receiver 192, correspondingly of the electrical power source 164 and the electrical device 172, etc., may be facilitated wirelessly, through a wired connection, through a Controller Area Network (CAN) connection, and/or through transmission modes which are now known or in the future developed.

Further, but not limited, the first receiver 180 and/or the second receiver 192 may include a receiver (or a transceiver) circuitry (not shown) that enables the controller 256 to monitor and/or read (e.g., by a suitable reader unit) the receipt of data to the first receiver 180 and/or the second receiver 192 and thus to one or more of the electrical power source 164 and/or the electrical device 172. In this regard, the receiver (or a transceiver) circuitry can include any appropriate circuitry, now known or in the future developed.

Processing units of the controller 256, to convert and/or process various input, command, signals, and/or the like, may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Examples of the memory 260 may include a hard disk drive (HDD), and a secure digital (SD) card. Further, the memory 260 may include non-volatile/volatile memory units such as a random-access memory (RAM)/a read only memory (ROM), which may include associated input and output buses. The memory 260 may be configured to store various other instruction sets for various other functions of the work machine 100 and/or the power system 224, along with the set of instruction, discussed above.

### INDUSTRIAL APPLICABILITY

As the work machine 100 operates at the worksite 108, the connection arrangement 228 may be in the mated state, i.e., the first piece 232 may be in the connected condition with the second piece 236, and therefore, the first terminal set 200 may be operatively engaged with the second terminal set 204 and also the first connector set 212 may be operatively engaged with the second connector set 216. In so doing, the electrical power supply may be routed from the electrical power source 164 to the electrical device 172 (or to the various other electrical devices) of the work machine 100 through the connection arrangement 228 allowing the work machine 100 to perform useful work. This is because the operative engagement (e.g., mechanical connection) of the first terminal set 200 with the second terminal set 204 provides passage to the electrical connection 208 between the electrical power source 164 and the electrical device 172.

During such operations of the work machine 100, the work machine 100 may use up an energy stored within the electrical power source 164 (e.g., the battery module 168) to perform the useful work, e.g., to power a movement of the work machine 100, actuate the implement 140, etc. Therefore, after a period of use, the electrical power source 164 may be drained out and/or discharged, and thus, the drained electrical power source 164 (e.g., a fully drained out electrical power source) may need to be replaced with the charged electrical power source 164 (e.g., a fully charged electrical power source).

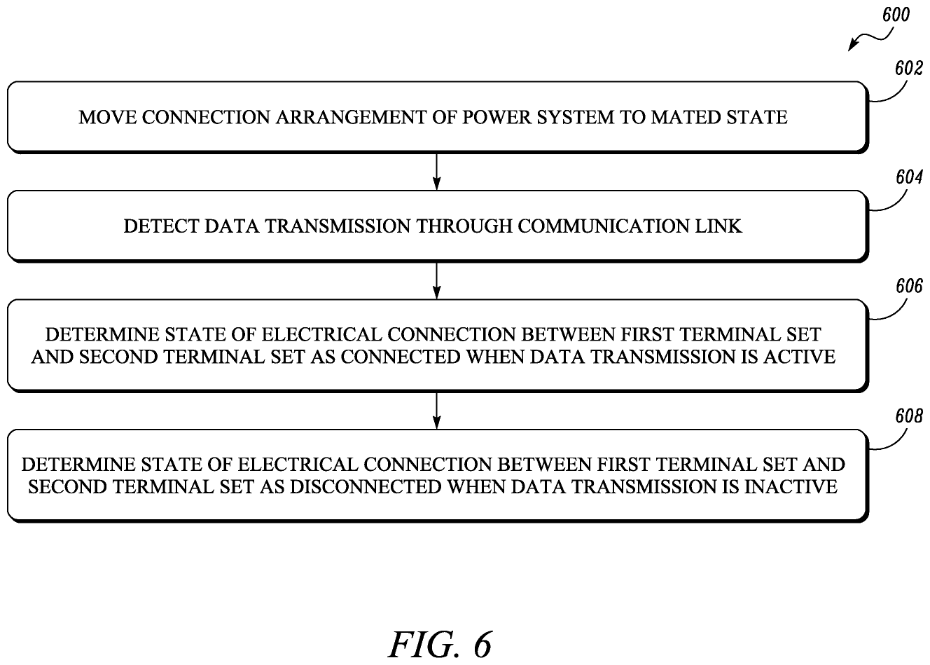

Referring to FIG. 6, an exemplary method of operation of the power system 224 (e.g., an exemplary operation of the connection arrangement 228 and the system 252) is discussed by way of a flowchart 600. The method is also discussed in conjunction with FIGS. 1 through 5. It will be appreciated that the method may exemplarily describe, at least in part, a process in which the drained electrical power source 164′ may be replaced with the charged electrical power source 164″. The method starts at stage 602.

At stage 602, an operator may move the connection arrangement 228 of the power system 224 between the mated state and the unmated state. As the drained electrical power source 164′ may need to be replaced with a charged electrical power source 164″, the connection arrangement 228 may be moved from the mated state (e.g., see FIGS. 2 and 4) to the unmated state (e.g., see FIGS. 3 and 5). The movement may be effectuated by an actuation of the actuator 240 by which also the first piece 232 may be moved away from the second piece 236 to switch the first piece 232 to the disconnected condition with respect to the second piece 236. Such a state of the connection arrangement 228 facilitates the replacement of the electrical power source 164 from the work machine 100 (e.g., removal of the drained electrical power source 164′ and the installation of the charged electrical power source 164″ on the work machine 100).

As the connection arrangement 228 is moved to the unmated state, the first terminal set 200 may be disengaged (e.g., mechanically disconnected) from the second terminal set 204 and the first connector set 212 may be disengaged (e.g., mechanically disconnected) from the second connector set 216. Therefore, at this point, both the electrical power supply through the electrical connection 208 and the data transmission through the communication link 220 may be restricted and/or altogether stopped given the aforementioned disengagement between the terminal sets (i.e., the first terminal set 200 and the second terminal set 204) and the connector sets (i.e., the first connector set 212 and the second connector set 216).

In the unmated state of the connection arrangement 228, the drained electrical power source 164′ may be removed from the connection arrangement 228 and/or from the rearward portion 120 of the main frame assembly 112 of the work machine 100 and the charged electrical power source 164″ may be brought forth and be mounted onto the rearward portion 120 of the main frame assembly 112 of the work machine 100. Once the charged electrical power source 164″ is mounted onto the rearward portion 120 of the main frame assembly 112, the first piece 232 may carry the first terminal set 200 and the first connector set 212 which may correspond to or extend from the newly installed, charged electrical power source 164″.

Next, the operator may move or return the connection arrangement 228 to the mated state, i.e., the operator may move or switch the first piece 232 to the connected condition with respect to the second piece 236 such that the operative engagement (e.g., mechanical connection) of the electrical power contacts, for example, the first terminal set 200 with the second terminal set 204 and the operative engagement (e.g., mechanical connection) of the datalink signal contacts, for example, the first connector set 212 with the second connector set 216 may be attained. Such movement may be assisted or performed by a reverse actuation of the actuator 240.

Further, the operator may check whether the charged electrical power source 164″ is properly installed to the connection arrangement 228 and thus to the work machine 100 such that electrical power from the charged electrical power source 164″ can be positively supplied to the electrical device 172 for the performance of one or more work machine operations. To perform such a check, the operator may verify whether the operative engagement of the first terminal set 200 with the second terminal set 204 to route the electrical power supply through the electrical connection 208 (and optionally whether the operative engagement of the first connector set 212 with the second connector set 216 to route the data transmission through the communication link 220) in the mated state is actually attained, or not. To perform such verification, e.g., once the connection arrangement 228 is moved to the mated state and/or the first piece 232 is switched to the connected condition with respect to the second piece 236, the operator may use the system 252 to determine or verify the state of the electrical connection 208 between the first terminal set 200 and the second terminal set 204.

In this regard, and at stage 604, the controller 256 may detect the data transmission through the communication link 220, e.g., by monitoring data receipt by one or more of the first receiver 180 and/or by the second receiver 192. The method proceeds to stage 606.

At stage 606, the controller 256 may determine the state of the electrical connection between the first terminal set 200 and the second terminal set 204 at the connection arrangement 228 as connected (or that the operative engagement between the first terminal set 200 and the second terminal set 204 is operational or complete) when the data transmission through the communication link 220 is active. In effect, the controller 256 may determine an active electrical connection between the first terminal set 200 and the second terminal set 204 when the first connector set 212 is operatively engaged with the second connector set 216 by the connection arrangement 228, and when the communication link 220 is passed between the electrical power source 164 (or the charged electrical power source 164) and the electrical device 172 through the connection arrangement 228 and the data transmission therebetween is routed through the connection arrangement 228. In some embodiments, the controller 256 may move the electrical-contactor 248 to the closed position (ON condition) (or ensure that the electrical-contactor 248 is in the closed position or ON condition) when the data transmission is active to electrically connect and bridge the operative engagement between the first terminal set 200 and the second terminal set 204.

In some embodiments, the controller 256 may be able to provide an output of such a state (e.g., connected state) of the electrical connection between the first terminal set 200 and the second terminal set 204 to the operator interface provided in the operator cabin 148 of the work machine 100.

Conversely, and as part of stage 608, the controller 256 may determine the state of the electrical connection between the first terminal set 200 and the second terminal set 204 at the connection arrangement 228 as disconnected (or that the operative engagement between the first terminal set 200 and the second terminal set 204 is faulty or incomplete) when the data transmission is inactive. In effect, the controller 256 may determine an inactive electrical connection between the first terminal set 200 and the second terminal set 204 when the first connector set 212 is not operatively engaged with the second connector set 216 by the connection arrangement 228, and when the communication link 220 is not passed between the electrical power source 164 (or the charged electrical power source 164) and the electrical device 172 through the connection arrangement 228 and the data transmission therebetween is not routed through the connection arrangement 228.

In some embodiments, the controller 256 may move the electrical-contactor 248 to the open position (OFF condition) when the data transmission is inactive to break (e.g., fully break) the operative engagement between the first terminal set 200 and the second terminal set 204 to set a voltage transfer value between the first terminal set 200 and the second terminal set 204 to zero (0) volt at the connection arrangement 228. In some embodiments, the controller 256 may be able to provide an output of such a state (e.g., disconnected state) of the electrical connection between the first terminal set 200 and the second terminal set 204 to the operator interface provided in the operator cabin 148 of the work machine 100.

In brevity, the communication link 220 serves as a sensor or a sensing means to detect a mechanical state of the electrical connection 208, e.g., whether the first terminal set 200 is operatively engaged with the second terminal set 204, or not. The system 252 may be applicable in cases even when the electrical power source 164 (or the charged electrical power source 164″) has been fully mounted to the rearward portion 120 of the work machine 100 and the work machine 100 is out of the exemplary electrical power source replacement procedure described above. In other words, the system 252 may not necessarily be executed only during the process when the replacement of the drained electrical power source 164 with the charged electrical power source 164″ is being carried out.

Further, by way of the power system 224, the operator can verify whether in the mated state of the connection arrangement 228 or when the first piece 232 is switched to the connected condition with respect to the second piece 236, the first terminal set 200 is still operatively engaged to the second terminal set 204 and whether an integrity of the electrical connection 208 through the connection arrangement 228 is achieved and/or maintained, or not. In that manner, the power system 224, and, in particular, the system 252 of the power system 224 is able to negate or altogether avoid manual intervention and rather helps perform an automatic check to see whether electrical connections between the electrical power source 164 (or the charged electrical power source 164″) and the electrical device 172 are properly engaged (or disengaged), in turn reducing procedural error, service effort, and manual labor, e.g., during the replacement of the electrical power source 164.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A power system for a work machine, the power system comprising:
a connection arrangement configured to be moved between a mated state and an unmated state to facilitate replacement of one or more electrical power sources of the work machine, wherein in the mated state, the connection arrangement facilitates an operative engagement of each of:
a first terminal set with a second terminal set to provide passage to an electrical connection therethrough and route electrical power supply from the one or more electrical power sources to one or more electrical devices of the work machine through the connection arrangement, and
a first connector set with a second connector set to provide passage to one or more communication links therethrough and route data transmission through the connection arrangement; and
a system for determining a state of the electrical connection between the first terminal set and the second terminal set, the system including:
a controller configured to:
detect the data transmission through the one or more communication links;
determine the state of the electrical connection between the first terminal set and the second terminal set at the connection arrangement as connected when the data transmission is active; and
determine the state of the electrical connection between the first terminal set and the second terminal set at the connection arrangement as disconnected when the data transmission is inactive.

2. The power system of claim 1, wherein when the first connector set is operatively engaged with the second connector set by the connection arrangement, the one or more communication links are configured to be passed between the one or more electrical power sources and the one or more electrical devices through the connection arrangement and the data transmission therebetween is configured to be routed through the connection arrangement.

3. The power system of claim 1, wherein the controller includes a first controller configured to be associated with the one or more electrical power sources, wherein to detect the data transmission through the one or more communication links, the first controller is configured to:
monitor receipt of data to a first receiver associated with the one or more electrical power sources.

4. The power system of claim 1, wherein the controller includes a second controller configured to be associated with the one or more electrical devices, wherein to detect the data transmission through the one or more communication links, the second controller is configured to:
monitor receipt of data to a second receiver associated with the one or more electrical devices of the work machine.

5. The power system of claim 1 further including one or more electrical-contactors, the controller configured to:
move the one or more electrical-contactors to an open position when the data transmission is inactive to break the operative engagement between the first terminal set and the second terminal set and to set a voltage transfer value between the first terminal set and the second terminal set to zero (0) volt at the connection arrangement, and
move the one or more electrical-contactors to a closed position when the data transmission is active to electrically connect and bridge the operative engagement between the first terminal set and the second terminal set.

6. The power system of claim 1, wherein data transmissible through the one or more communication links corresponds to one or more of digital data, analog signal data, optical data, and fluid based signal data capable of facilitating a handshake type function with various devices of the work machine, or a combination of these.

7. The power system of claim 1, wherein the connection arrangement includes:
a first piece carrying the first terminal set and the first connector set, and
a second piece complementary to the first piece and carrying the second terminal set and the second connector set, the first piece switchable between a connected condition and a disconnected condition with respect to the second piece, wherein
the connected condition of the first piece with the second piece relates to the mated state of the connection arrangement and corresponds to:
the operative engagement of the first terminal set with the second terminal set and the operative engagement of the first connector set with the second connector set, and
the disconnected condition of the first piece with the second piece relates to the unmated state of the connection arrangement and corresponds to:
a disengagement between the first terminal set and the second terminal set to restrict the electrical power supply through the electrical connection, and a disengagement between the first connector set and the second connector set to restrict the data transmission through the one or more communication links.

8. A method of operation of a power system of a work machine, the method comprising:
moving a connection arrangement of the power system between a mated state and an unmated state to facilitate replacement of one or more electrical power sources of the work machine, wherein in the mated state of the connection arrangement, the connection arrangement facilitates an operative engagement of each of:
a first terminal set with a second terminal set to provide passage to an electrical connection therethrough and route electrical power supply from the one or more electrical power sources to one or more electrical devices of the work machine through the connection arrangement, and
a first connector set with a second connector set to provide passage to one or more communication links therethrough and route data transmission through the connection arrangement,
detecting, by a controller, the data transmission through the one or more communication links;
determining, by the controller, a state of the electrical connection between the first terminal set and the second terminal set as connected when the data transmission is active; and
determining, by the controller, the state of the electrical connection between the first terminal set and the second terminal set as disconnected when the data transmission is inactive.

9. The method of claim 8, wherein
when the first connector set is operatively engaged with the second connector set by the connection arrangement, the one or more communication links are configured to be passed between the one or more electrical power sources and the one or more electrical devices through the connection arrangement and the data transmission therebetween is configured to be routed through the connection arrangement.

10. The method of claim 8, wherein the controller includes a first controller associated with the one or more electrical power sources, wherein detecting data transmission through the one or more communication links includes:
monitoring, by the first controller, receipt of data to a first receiver associated with the one or more electrical power sources.

11. The method of claim 8, wherein the controller includes a second controller associated with the one or more electrical devices, wherein detecting data transmission through the one or more communication links include:
monitoring, by the second controller, receipt of data to a second receiver associated with the one or more electrical devices of the work machine.

12. The method of claim 8, wherein the power system includes one or more electrical-contactors, the method including:
moving, by the controller, the one or more electrical-contactors to an open position when the data transmission is inactive to break the operative engagement between the first terminal set and the second terminal set and to set a voltage transfer value between the first terminal set and the second terminal set to zero (0) volt at the connection arrangement, and
moving, by the controller, the one or more electrical-contactors to a closed position when the data transmission is active to electrically connect and bridge the operative engagement between the first terminal set and the second terminal set.

13. The method of claim 8, wherein data transmissible through the one or more communication links corresponds to one or more of digital data, analog signal data, optical data, and fluid based signal data capable of facilitating a handshake type function with various devices of the work machine, or a combination of these.

14. The method of claim 8, wherein the connection arrangement includes:
a first piece carrying the first terminal set and the first connector set and
a second piece complementary to the first piece and carrying the second terminal set and the second connector set, the first piece switchable between a connected condition and a disconnected condition with respect to the second piece, wherein
the connected condition of the first piece with the second piece relates to the mated state of the connection arrangement and corresponds to:
the operative engagement of the first terminal set with the second terminal set and the operative engagement of the first connector set with the second connector set, and
the disconnected condition of the first piece with the second piece relates to the unmated state of the connection arrangement and corresponds to:
a disengagement between the first terminal set and the second terminal set to restrict the electrical power supply through the electrical connection, and a disengagement between the first connector set and the second connector set to restrict the data transmission through the one or more communication links.

15. A work machine, comprising:
one or more electrical power sources;
one or more electrical devices powerable by the one or more electrical power sources;
a first terminal set and a second terminal set configured to be operatively engaged with each other to provide passage to an electrical connection therethrough for facilitating electrical power supply from the one or more electrical power sources to the one or more electrical devices;
a first connector set and a second connector set configured to be operatively engaged with each other to provide passage to one or more communication links therethrough for facilitating data transmission therethrough;
a power system including a connection arrangement configured to be moved between a mated state and an unmated state to facilitate replacement of the one or more electrical power sources, wherein in the mated state, the connection arrangement facilitates an operative engagement of:
the first terminal set with the second terminal set to route the electrical power supply through the connection arrangement, and
the first connector set with the second connector set to route the data transmission through the connection arrangement; and
a system for determining a state of the electrical connection between the first terminal set and the second terminal set, the system including:
a controller configured to:
detect the data transmission through the one or more communication links;
determine the state of the electrical connection between the first terminal set and the second terminal set at the connection arrangement as connected when the data transmission is active; and
determine the state of the electrical connection between the first terminal set and the second terminal set at the connection arrangement as disconnected when the data transmission is inactive.

16. The work machine of claim 15, wherein when the first connector set is operatively engaged with the second connector set by the connection arrangement, the one or more communication links are configured to be passed between the one or more electrical power sources and the one or more electrical devices through the connection arrangement and the data transmission therebetween is configured to be routed through the connection arrangement.

17. The work machine of claim 15, wherein the controller includes a first controller configured to be associated with the one or more electrical power sources, wherein to detect the data transmission through the one or more communication links, the first controller is configured to:
monitor receipt of data to a first receiver associated with the one or more electrical power sources.

18. The work machine of claim 15, wherein the controller includes a second controller configured to be associated with the one or more electrical devices, wherein to detect the data transmission through the one or more communication links, the second controller is configured to:
monitor receipt of data to a second receiver associated with the one or more electrical devices of the work machine.

19. The work machine of claim 15, wherein the power system includes one or more electrical-contactors, the controller configured to:
move the one or more electrical-contactors to an open position when the data transmission is inactive to break the operative engagement between the first terminal set and the second terminal set and to set a voltage transfer value between the first terminal set and the second terminal set to zero (0) volt at the connection arrangement, and
move the one or more electrical-contactors to a closed position when the data transmission is active to electrically connect and bridge the operative engagement between the first terminal set and the second terminal set.

20. The work machine of claim 15, wherein the connection arrangement includes:
a first piece carrying the first terminal set and the first connector set and
a second piece complementary to the first piece and carrying the second terminal set and the second connector set, the first piece switchable between a connected condition and a disconnected condition with respect to the second piece, wherein
the connected condition of the first piece with the second piece relates to the mated state of the connection arrangement and corresponds to:
the operative engagement of the first terminal set with the second terminal set and the operative engagement of the first connector set with the second connector set, and
the disconnected condition of the first piece with the second piece relates to the unmated state of the connection arrangement and corresponds to:
a disengagement between the first terminal set and the second terminal set to restrict the electrical power supply through the electrical connection, and a disengagement between the first connector set and the second connector set to restrict the data transmission through the one or more communication links.
